(19) United States
(12) Patent Application Publication
(10) Pub. No.: US 2015/0123956 A1
(43) Pub. Date: May 7, 2015

(54) IMAGE DISPLAY APPARATUS, CONTROL METHOD OF IMAGE DISPLAY APPARATUS, LIGHT SOURCE APPARATUS, AND CONTROL METHOD OF LIGHT SOURCE APPARATUS

(71) Applicant: CANON KABUSHIKI KAISHA, Tokyo (JP)

(72) Inventor: Masanao Kurita, Isehara-shi (JP)

(21) Appl. No.: 14/526,923

(22) Filed: Oct. 29, 2014

(30) Foreign Application Priority Data
Nov. 5, 2013 (JP) 2013-229445

(51) Int. Cl. G09G 3/34; G09G 3/36; H05B 37/02

(52) U.S. Cl. CPC G09G 3/3406; H05B 37/0218; G09G 3/36; G09G 2320/0626; G09G 2330/021; G09G 2360/141
USPC 345/207; 315/149; 345/87

(57) ABSTRACT

An image display apparatus includes N detecting units, a light emitting unit having n light sources for each of the detecting units, a control unit configured to control light emission of the light sources, a storage unit configured to store, for each combination of the light source and a detecting unit that does not correspond to the light source, a degree of influence of light from the light source on a detection value, and an acquiring unit configured to acquire a light value of the light source on the basis of N detection values that are obtained in the state where the N light sources are being turned on and the degrees, wherein the control unit performing processing of turning on the N light sources n times to acquire light values of N×n light sources.

### BACKGROUND OF THE INVENTION

1. Field of the Invention

The present invention relates to an image display apparatus, a control method of an image display apparatus, a light source apparatus, and a control method of a light source apparatus.

2. Description of the Related Art

A liquid crystal display apparatus that is capable of displaying a color image generally includes a liquid crystal panel having color filters and a backlight apparatus that irradiates the back face of the liquid crystal panel with white light.

Conventionally, a fluorescent lamp such as a cold cathode fluorescent lamp (CCFL) is mainly used as a light emitting element of a backlight apparatus. However, in recent years, a light emitting diode (LED), which is excellent in terms of electric power consumption, lifetime, color reproducibility, and load on the environment is increasingly used as a light emitting element of a backlight apparatus.

A backlight apparatus that has LEDs as light emitting elements (an LED backlight apparatus) generally has a large number of LEDs. Japanese Patent Application Laid-open No. 2001-142409 discloses a backlight apparatus that has a plurality of light sources (light emitting blocks) whose light emission brightness is individually controllable. Each of the light sources has one or more LEDs. The plurality of light sources corresponds to a plurality of divided regions that constitute a screen, and the plurality of light sources irradiates the corresponding divided regions with light. According to a liquid crystal display apparatus that has such a backlight apparatus, it is possible to reduce electric power consumption and improve contrast of a displayed image by reducing light emission brightness of a light source that corresponds to a divided region where a dark image is displayed. Control of light emission brightness of light sources depending on characteristics of an image is called local dimming control.

However, local dimming control sometimes causes unexpected unevenness (brightness unevenness and color unevenness) in light from a backlight apparatus. Specifically, local dimming control sometimes causes a difference in the temperature among light sources. When the temperature of a light source changes, brightness and color of light emitted from the light source also change.

Accordingly, when a difference in the temperature among light sources occurs, unexpected unevenness occurs. Moreover, local dimming control sometimes causes a difference in the degree of aged deterioration among light sources. When the degree of aged deterioration of a light source changes, brightness and color of light emitted from the light source also change. Accordingly, when a difference in the degree of aged deterioration among light sources occurs, unexpected unevenness occurs. Moreover, when there is a variation in the temperature and the degree of aged deterioration among light sources, unevenness occurs in light from a backlight apparatus in the case of driving the light sources by an identical driving signal.

As a technique for reducing such unevenness, there is a technique of performing, for all light sources, processing of turning on a light source and detecting light from the light source with a light sensor and controlling (correcting) light emission of each light source on the basis of a detection value obtained by the light sensor.

However, according to this technique, as the number of light sources increases, it takes more time to acquire detection values for all of the light sources.

According to the technique disclosed in WO 2008/029548, detection values for a plurality of light sources are concurrently acquired with the use of a plurality of light sensors that correspond to the plurality of light sources in a state in which the plurality of light sources are turned on. This makes it possible to shorten a period of time which it takes to acquire detection values for all of the light sources.

### SUMMARY OF THE INVENTION

However, light from a light source leaks to another divided region. Therefore, according to the technique disclosed in WO 2008/029548, a detection value obtained by a light sensor undesirably contains a large detection error. In other words, it is impossible to accurately acquire, as a detection value obtained by a light sensor, a light value indicative of light from a light source that corresponds to the light sensor.

The present invention provides a technique of accurately acquiring light values of all light sources in a short time.

The present invention in its first aspect provides

an image display apparatus comprising:

N detecting units, N being an integer of 2 or more;

a light emitting unit having n light sources for each of the detecting units, n being an integer of 2 or more;

a display unit configured to display an image on a screen by modulating light from the light emitting unit; and

a control unit configured to control light emission of the light sources,

in a state where N light sources that correspond to the N detecting units are being turned on by the control unit, each of the detecting units detects synthetic light of light from a light source that corresponds to the detecting unit and light from a light source other than the light source that corresponds to the detecting unit,

the image display apparatus further comprising:

a storage unit configured to store, for each combination of the light source and a detecting unit that does not correspond to the light source, a degree of influence of light from the light source on a detection value of the detecting unit; and

an acquiring unit configured to acquire, for each of the N light sources, a light value indicative of light from the light source on the basis of N detection values of the N detecting units that are obtained in the state where the N light sources are being turned on by the control unit and the degree of influence for each combination,

wherein the control unit performing processing of turning on the N light sources that correspond to the N detecting units n times to acquire light values of N×n light sources.

The present invention in its second aspect provides

a light source apparatus comprising:

N detecting units, N being an integer of 2 or more;

a light emitting unit having n light sources for each of the detecting units, n being an integer of 2 or more; and

a control unit configured to control light emission of the light sources,

in a state where N light sources that correspond to the N detecting units are being turned on by the control unit, each of the detecting units detects synthetic light of light from a light source that corresponds to the detecting unit and light from a light source other than the light source that corresponds to the detecting unit,

the light source apparatus further comprising:

a storage unit configured to store, for each combination of the light source and a detecting unit that does not correspond to the light source, a degree of influence of light from the light source on a detection value of the detecting unit; and

an acquiring unit configured to acquire, for each of the N light sources, a light value indicative of light from the light source on the basis of N detection values of the N detecting units that are obtained in the state where the N light sources are being turned on by the control unit and the degree of influence for each combination,

wherein the control unit performing processing of turning on the N light sources that correspond to the N detecting units n times to acquire light values of N×n light sources.

The present invention in its third aspect provides

a control method of an image display apparatus including:

N detecting units, N being an integer of 2 or more;

a light emitting unit having n light sources for each of the detecting units, n being an integer of 2 or more;

a display unit configured to display an image on a screen by modulating light from the light emitting unit; and

a storage unit configured to store, for each combination of a light source and a detecting unit that does not correspond to the light source, a degree of influence of light from the light source on a detection value of the detecting unit,

the control method comprising:

a control step of controlling light emission of the light sources; and

an acquiring step of acquiring, for each of the light sources, a light value indicative of light from the light source,

wherein, in a state where N light sources that correspond to the N detecting units are being turned on in the control step, each of the detecting units detects synthetic light of light from a light source that corresponds to the detecting unit and light from a light source other than the light source that corresponds to the detecting unit,

in the acquiring step, for each of the N light sources, a light value indicative of light from the light source is acquired on the basis of N detection values of the N detecting units that are obtained in the state where the N light sources are being turned on in the control step and the degree of influence for each combination, and

in the control step, processing of turning on the N light sources that correspond to the N detecting units is performed n times to acquire light values of N×n light sources.

The present invention in its fourth aspect provides

a control method of a light source apparatus including:

N detecting units, N being an integer of 2 or more;

a light emitting unit having n light sources for each of the detecting units, n being an integer of 2 or more; and

a storage unit configured to store, for each combination of a light source and a detecting unit that does not correspond to the light source, a degree of influence of light from the light source on a detection value of the detecting unit,

the control method comprising:

a control step of controlling light emission of the light sources; and

an acquiring step of acquiring, for each of the light sources, a light value indicative of light from the light source,

wherein, in a state where N light sources that correspond to the N detecting units are being turned on in the control step, each of the detecting units detects synthetic light of light from a light source that corresponds to the detecting unit and light from a light source other than the light source that corresponds to the detecting unit,

in the acquiring step, for each of the N light sources, a light value indicative of light from the light source is acquired on the basis of N detection values of the N detecting units that are obtained in the state where the N light sources are being turned on in the control step and the degree of influence for each combination, and

in the control step, processing of turning on the N light sources that correspond to the N detecting units is performed n times to acquire light values of N×n light sources.

The present invention in its fifth aspect provides a non-transitory computer readable medium that stores a program, wherein the program causes a computer to execute the above mentioned control method of the image display apparatus.

The present invention in its sixth aspect provides a non-transitory computer readable medium that stores a program, wherein the program causes a computer to execute the control method of the light source apparatus.

According to the present invention, light values of all light sources can be accurately acquired in a short time.

Further features of the present invention will become apparent from the following description of exemplary embodiments with reference to the attached drawings.

### BRIEF DESCRIPTION OF THE DRAWINGS

FIG. 1 is a schematic view illustrating an example of a configuration of a color image display apparatus according to Embodiment 1;

FIG. 2 is a schematic view illustrating an example of a configuration of a light source substrate according to Embodiment 1;

FIG. 3 is a schematic view illustrating an example of a configuration of an LED substrate according to Embodiment 1;

FIG. 4 is a schematic view illustrating an example of how the LED substrates, light sources, and light sensors are disposed according to Embodiment 1;

FIG. 5 is a block diagram illustrating an example of a configuration of a backlight apparatus according to Embodiment 1;

FIG. 6 is a view illustrating an example of the selection order of target light sources and detection light sensors according to Embodiment 1;

FIG. 7 is a schematic view illustrating an example of a lighting state in light emission adjusting processing according to Embodiment 1;

FIGS. 8A and 8B are schematic views each illustrating an example of a light detection value in the light emission adjusting processing according to Embodiment 1;

FIG. 9 is a flowchart illustrating an example of a procedure of acquiring a degree of influence according to Embodiment 1;

FIG. 10 is a schematic view illustrating an example of processing in S101 and S102 in FIG. 9;

FIG. 11 is a schematic view illustrating an example of processing in S104 and S105 in FIG. 9;

FIG. 12 is a flowchart illustrating an example of a procedure of the light emission adjusting processing according to Embodiment 1;

FIG. 13 is a view illustrating an example of the selection order of target light sources and detection light sensors according to Embodiment 2; and

FIG. 14 is a schematic view illustrating an example of a lighting state in the light emission adjusting processing according to Embodiment 2.

### DESCRIPTION OF THE EMBODIMENTS

### Embodiment 1

Alight source apparatus and a control method of the light source apparatus according to Embodiment 1 of the present invention are described below.

In the following description, an example in which the light source apparatus according to the present embodiment is used in an image display apparatus that displays an image on a screen by modulating light from the light source apparatus is described. However, the light source apparatus according to the present embodiment is not limited to this. The light source apparatus according to the present embodiment may be, for example, an illumination apparatus such as a street lamp or interior illumination.

In the following description, an example in which an image display apparatus according to the present embodiment is a transmissive liquid crystal display apparatus is described. However, the image display apparatus according to the present embodiment is not limited to this. The image display apparatus according to the present embodiment can be any image display apparatus as long as it is an image display apparatus that displays an image on a screen by modulating light from the light source apparatus. For example, the image display apparatus according to the present embodiment may be a reflective liquid crystal display apparatus. Alternatively, the image display apparatus according to the present embodiment may be a micro electro mechanical system (MEMS) shutter display that uses an MEMS shutter instead of a liquid crystal element.

In the following description, an example in which the image display apparatus according to the present embodiment is a color image display apparatus is described. However, the image display apparatus according to the present embodiment may be a monochromatic image display apparatus.

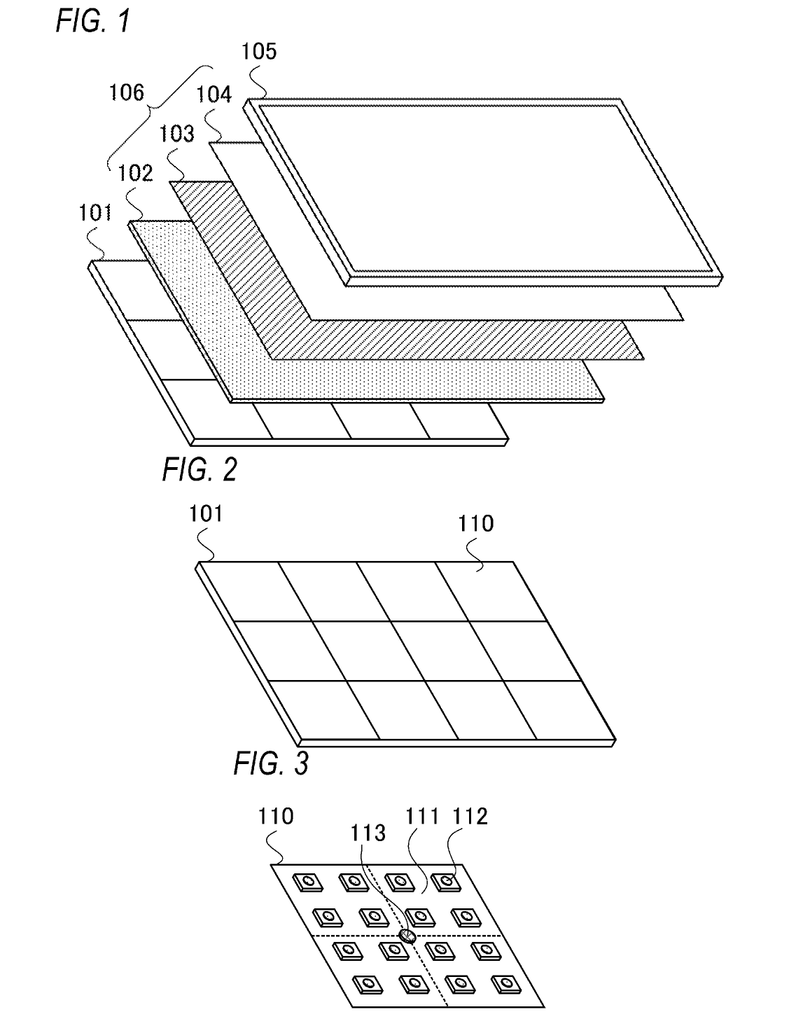

FIG. 1 is a schematic view illustrating an example of a configuration of a color image display apparatus according to the present embodiment. The color image display apparatus includes a backlight apparatus (light source apparatus) and a color liquid crystal panel 105. The backlight apparatus includes a light source substrate 101, a diffusion plate 102, a light collecting sheet 103, and a reflective polarizing film 104.

The light source substrate 101 is a light emitting unit that emits light (white light) with which the back face of the color liquid crystal panel 105 is irradiated. The light source substrate 101 has a plurality of light sources. Each of the light sources has one or more light emitting elements. As the light emitting element, a light emitting diode (LED), a cold-cathode tube, an organic EL element or the like can be used.

The diffusion plate 102, the light collecting sheet 103, and the reflective polarizing film 104 are disposed in parallel with the light source substrate 101, and give optical changes to light from the light source substrate 101.

Specifically, the diffusion plate 102 diffuses light emitted from the plurality of light emitting elements (LED chips in the present embodiment). This allows the light source substrate 101 to function as a planar light source.

The light collecting sheet 103 collects, in a front direction (the color liquid crystal panel 105 side), white light that has been diffused by the diffusion plate 102 and has enter the light collecting sheet 103 at various incident angles, and thereby improves front brightness (brightness (luminance) in the front direction).

The reflective polarizing film 104 improves the front brightness by effectively polarizing the incident white light.

The diffusion plate 102, the light collecting sheet 103, and the reflective polarizing film 104 are stacked on each other. Hereinafter, these optical members are collectively referred to as an optical sheet 106. It should be noted that the optical sheet 106 may be arranged to include a member other than the above optical members and may be arranged not to include at least one of the above optical members. The optical sheet 106 and the color liquid crystal panel 105 may be integral with each other.

The color liquid crystal panel 105 is a display unit that displays an image on a screen by modulating light from the light source substrate 101. Specifically, the color liquid crystal panel 105 displays an image on the screen by modulating light that has been emitted from the light source substrate 101 and undergone the optical changes in the optical sheet 106. In the present embodiment, the color liquid crystal panel 105 has a plurality of pixels each made up of an R sub-pixel that transmits red light, a G sub-pixel that transmits green light, and a B sub-pixel that transmits blue light, and displays a color image by controlling, for each sub-pixel, brightness of emitted white light.

A backlight apparatus having the configuration as described above (the configuration as illustrated in FIG. 1) is generally called a direct type backlight apparatus.

FIG. 2 is a schematic view illustrating an example of a configuration of the light source substrate 101.

The light source substrate 101 has a plurality of LED substrates 110.

In the example of FIG. 2, the light source substrate 101 has twelve LED substrates 110 that are disposed in a matrix of three rows and four columns. The present embodiment deals with a case where the light source substrate 101 has a plurality of LED substrates, but is not limited to this. The light source substrate 101 may has a single LED substrate. For example, the light source substrate 101 may have a single LED substrate that combines the twelve LED substrates 110.

FIG. 3 is a schematic view illustrating an example of a configuration of each of the LED substrates 110.

Each of the LED substrates 110 has n (n is an integer of 1 or more) light sources 111. In the example of FIG. 3, each of the LED substrates 110 has a total of four light sources 111 that are disposed in two rows and two columns. Accordingly, the light source substrate 101 has a total of forty eight light sources 111 that are disposed in six rows and eight columns.

Each of the light sources 111 has one or more light emitting elements (LED chips 112). In the example of FIG. 3, each of the light sources 111 has a total of four LED chips 112 that are disposed in two rows and two columns. Light emission brightness of the light sources 111 is individually controllable. For example, the four LED chips 112 provided in each of the light sources 111 are serially connected to each other. As the LED chips 112, white LEDs that emit white light can be, for example, used.

It should be noted that chips that are configured so that white light is obtained with the use of a plurality of LEDs that emit light of different colors (for example, a red LED that emits red light, a green LED that emits green light, and a blue LED that emits blue light) may be used as the LED chips 112.

In the present embodiment, the plurality of LED chips 112 are disposed at regular intervals, but the plurality of LED chips 112 may be arranged not to be disposed at regular intervals.

Each of the LED substrates 110 includes a light sensor 113 (detecting unit) that detects light from the light source substrate 101 and outputs a detection value (light detection value). Part of light from the light sources 111 is reflected by the optical sheet (the diffusion plate, the reflective polarizing film, etc.) back toward the light source side. The light sensor 113 is provided so as to face the optical sheet 106, and detects the reflected light that has been reflected by the optical sheet 106 back toward the light source side. Light emission brightness of the light sources 111 can be estimated from brightness of the reflected light. In the present embodiment, a single light sensor 113 is provided per the LED substrate 110 (per the four light sources). Accordingly, the light source substrate 101 has twelve light sensors 113. A sensor, such as a photodiode or a photo transistor, that outputs brightness as a light detection value can be used as the light sensor 113. Alternatively, a color sensor that outputs a color change in addition to brightness can be used as the light sensor 113.

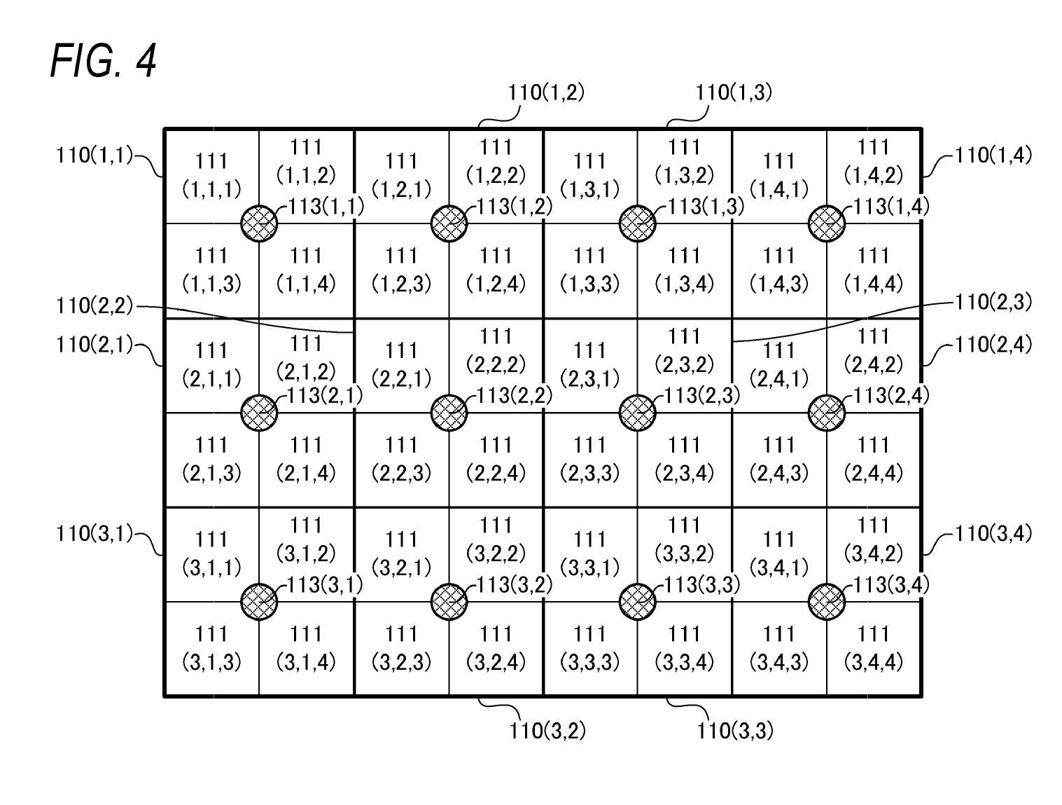

FIG. 4 is a schematic view illustrating an example of how the LED substrates 110, the light sources 111, and the light sensors 113 are disposed when viewed from the front direction (the color liquid crystal panel 105 side). On the right side of an LED substrate 110 (1, 1) disposed at an upper left corner, an LED substrate 110 (1, 2), an LED substrate 110 (1, 3), and an LED substrate 110 (1, 4) are disposed in this order. On the lower side of the LED substrate 110 (1, 1), an LED substrate 110 (2, 1) and an LED substrate 110 (3, 1) are disposed in this order. On the lower side of the LED substrate 110 (1, 2), an LED substrate 110 (2, 2) and LED substrate 110 (3, 2) are disposed in this order. On the lower side of the LED substrate 110 (1, 3), an LED substrate 110 (2, 3) and an LED substrate 110 (3, 3) are disposed in this order. On the lower side of the LED substrate 110 (1, 4), an LED substrate 110 (2, 4) and an LED substrate 110 (3, 4) are disposed in this order.

An LED substrate 110 (X, Y) (X=1 to 3, Y=1 to 4) has four light sources 111 (X, Y, Z) (Z=1 to 4) and a single light sensor 113 (X, Y). For example, the LED substrate 110 (1, 1) has a light source 111 (1, 1, 1), a light source 111 (1, 1, 2), a light source 111 (1, 1, 3), a light source 111 (1, 1, 4), and a light sensor 113 (1, 1). Z is a value that represents a position of a light source 111. Specifically, Z is 1 in a case where the light source 111 is positioned in the first row and the first column, Z is 2 in a case where the light source 111 is positioned in the first row and the second column, Z is 3 in a case where the light source 111 is positioned in the second row and the first column, and Z is 4 in a case where the light source 111 is positioned in the second row and the second column.

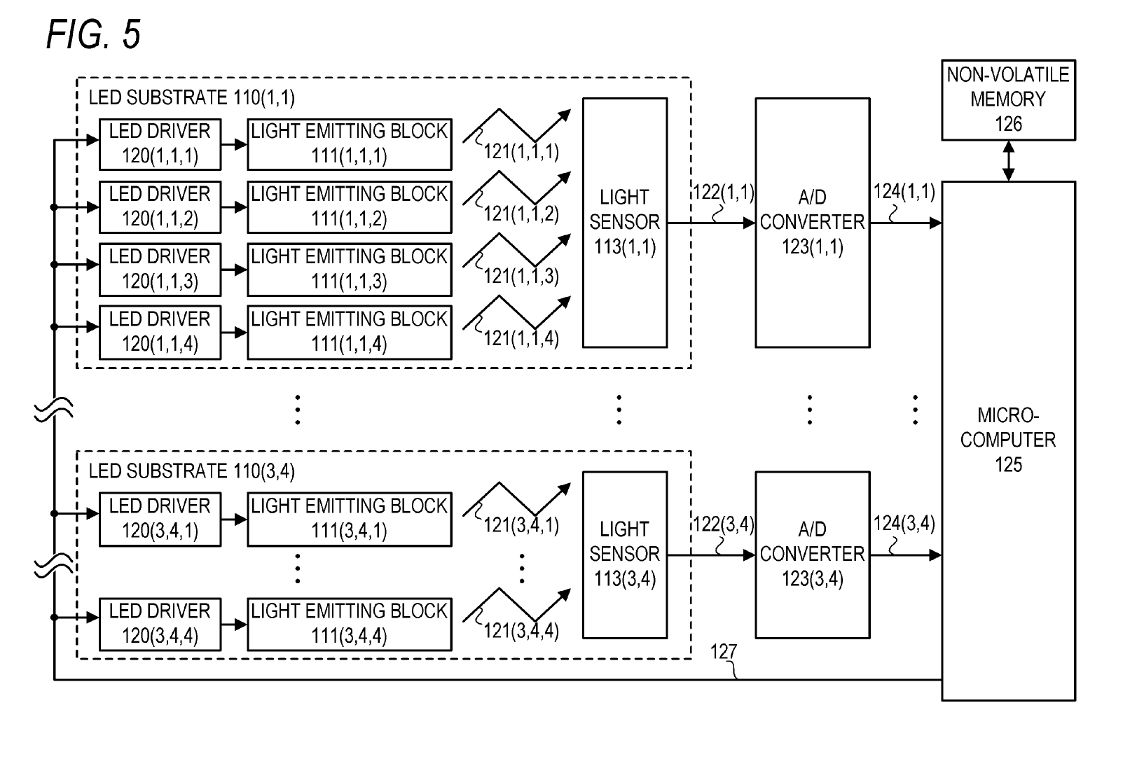

FIG. 5 is a block diagram illustrating an example of a configuration of the backlight apparatus.

Since the twelve LED substrates 110 have an identical configuration, the configuration of the LED substrate 110 (1, 1) is described below as an example. The LED substrate 110 (1, 1) has the light sources 111 (1, 1, 1) to 111 (1, 1, 4). The light sources 111 (1, 1, 1) to 111 (1, 1, 4) are driven by LED drivers 120 (1, 1, 1) to (1, 1, 4). A large part of light 121 (1, 1, 1) emitted from the light source 111 (1, 1, 1) enters the color liquid crystal panel 105 (not illustrated in FIG. 5), but part of the light 121 (1, 1, 1) is reflected by the optical sheet 106 (not illustrated in FIG. 5) and enters the light sensor 113 (1, 1). The same applies also to light 121 (1, 1, 2) to (1, 1, 4) emitted from the light sources 111 (1, 1, 2) to 111 (1, 1, 4).

In the present embodiment, light emission adjusting processing for reducing unexpected unevenness (brightness unevenness and color unevenness) is performed regularly or at a certain timing. In the light emission adjusting processing, light emitted from the light sources 111 is detected, and light emission of the light sources 111 is controlled (adjusted) on the basis of the result of the detection of the light. Details of the light emission adjusting processing will be described later. The unexpected unevenness occurs, for example, due to a difference in the temperature among the light sources 111, a difference in the degree of aged deterioration among the light sources 111, etc. In a case where the brightness unevenness is reduced, for example, brightness of light is detected, and then light emission brightness of the light sources 111 is controlled. In a case where the color unevenness is reduced, for example, color of light is detected, and then color of light emitted from the light sources 111 is controlled.

The light sensor 113 (1, 1) detects light hat has entered the light sensor 113 (1, 1) and outputs an analog value 122 (1, 1) that represents the light.

The backlight apparatus includes A/D converters 123 (1, 1) to 123 (3, 4) that correspond to the light sensors 113 (1, 1) to 113 (3, 4). The A/D converter 123 (1, 1) performs analog-digital conversion of the analog value 122 (1, 1) outputted from the light sensor 113 (1, 1) into a digital value 124 (1, 1), and then outputs the digital value 124 (1, 1) to a microcomputer 125. Similarly, the other A/D converters 123 also perform analog-digital conversion of analog values 122 outputted from corresponding light sensors 113 into digital values 124, and then output the digital values 124 to the microcomputer 125.

In a non-volatile memory 126, a target value for a light value indicative of light from a light source 111 is recorded in advance for each of the plurality of light sources 111. The target value is determined at timing such as the time of production or inspection of the image display apparatus. In a case where each of the light sources 111 emits light so that a light value of each of the light sources 111 coincides with the target value, light without unevenness is emitted from the backlight apparatus.

Furthermore, influence information that will be described later is stored in the non-volatile memory 126.

The microcomputer 125 controls light emission (light emission brightness and color of emitted light) of the light sources 111 on the basis of a light detection value (specifically, a digital value 124) obtained by the light sensor 113. In the present embodiment, the microcomputer 125 acquires light values of the light sources 111 on the basis of a light detection value obtained by the light sensor 113, and controls light emission of the light sources 111 so that the light values of the light sources 111 coincide with the target values recorded in the non-volatile memory 126.

The light emission brightness is adjusted, for example, by adjusting an LED driver control signal 127 supplied from the microcomputer 125 to the LED drivers 120. The LED drivers 120 drive the light sources 111 in accordance with the LED driver control signal. The LED driver control signal represents, for example, a pulse width of a pulse signal (a pulse signal of an electric current or a voltage) applied to the light sources 111. In this case, light emission brightness of the light sources 111 is PWM-controlled by adjusting the LED driver control signal. It should be noted that the LED driver control signal is not limited to this. For example, the LED driver control signal may be a peak value of a pulse signal applied to the light sources 111 or may be both of the pulse width and the peak value.

The color of emitted light is adjusted, for example, by adjusting the ratio of light emission brightness among a plurality of light emitting elements (a plurality of light emitting elements that emit light of different colors) of the light sources 111.

Details of an acquiring method of a light value will be described later.

The following describes details of the light emission adjusting processing according to the present embodiment.

In the light emission adjusting processing according to the present embodiment, N (N is an integer of 2 or more) light sources provided in different LED substrates 110 are (concurrently) turned on by the microcomputer 125.

Then, in this lighting state, light detection is performed with the use of N light sensors 113 that correspond to the N light sources. Light from a light source 111 enters not only a corresponding light sensor 113 but also other light sensors 113 (light leakage). Accordingly, each of the light sensors 113 detects synthetic light of light from a light source that corresponds to the light sensor 113 and light from light sources other than the corresponding light source.

Subsequently, N light values of the N light sources are acquired by the microcomputer 125 on the basis of the result of the light detection (N light detection values obtained by the N light sensors 133) and the influence information stored in the non-volatile memory 126. Accordingly, the processing of turning on the N light sources is performed n times by the microcomputer 125 in order to acquire light values of N×n light sources of the N LED substrates 110. The influence information is information that indicates, for each combination of a light source 111 and a light sensor 113 that does not correspond to the light source 111, a degree of influence of light from the light source 111 on a light detection value of the light sensor 113 that does not correspond to the light source 111.

In the present embodiment, a light value can be accurately acquired by using the influence information. Specifically, a light value in which the error caused by light leakage is reduced can be acquired. Furthermore, in the present embodiment, light values of N light sources are acquired by concurrently turning on the N light sources. This makes it possible to shorten a period of time which it takes to acquire the light values of the N light sources. This eventually shortens a period of time which it takes to acquire light values of all of the light sources. Specifically, it is possible to acquire light values of a plurality of light sources in a shorter time than a case where the light values are acquired by turning on the light sources one by one.

The present embodiment describes an example in which light values are acquired by the microcomputer 125, but light values may be acquired by a functional unit other than the microcomputer 125. For example, the backlight apparatus may include an acquiring unit that acquires light values of the light sources.

The influence information may be or may not be generated at timing such as the time of production or inspection of the image display apparatus and stored in the non-volatile memory 126. For example, the backlight apparatus may include a recording unit that acquires (generates) the influence information and records the influence information in the non-volatile memory 126. Such processing may be performed in the microcomputer 125 or the acquiring unit.

An example in which N is 2 is described below.

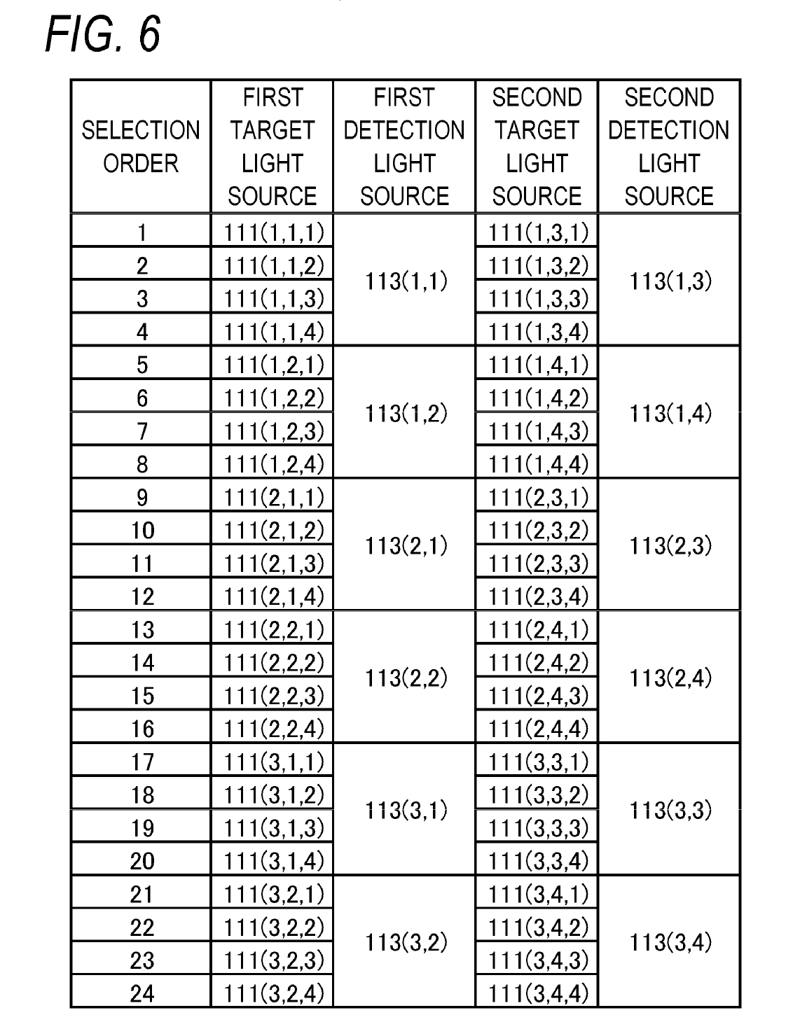

FIG. 6 is a view illustrating an example of the selection order of the light sources 111 that are turned on in the light emission adjusting processing and the light sensors 113 that are used for light detection in the light emission adjusting processing. In the present embodiment, a first target light source and a second target light source are turned on in the order illustrated in FIG. 6. Then, in the state where the first target light source and the second target light source are turned on, light detection using a first detection light sensor and a second detection light sensor is performed.

In the example of FIG. 6, one of a plurality of light sources 111 disposed in a left half region of the backlight apparatus when viewed from the front direction (the color liquid crystal panel 105 side) is selected as the first target light source. One of the plurality of light sources 111 disposed in a right half region is selected as the second target light source. Then, a light sensor 113 that corresponds to the first target light source is selected as the first detection light sensor, and a light sensor 113 that corresponds to the second target light source is selected as the second detection light sensor. In other words, a light sensor 113 that is disposed on an LED substrate 110 on which the first target light source is disposed is selected as the first detection light sensor, and a light sensor 113 that is disposed on an LED substrate 110 on which the second target light source is disposed is selected as the second detection light sensor.

For example, in the first light emission adjusting processing, the light source 111 (1, 1, 1) is selected as the first target light source, and the light source 111 (1, 3, 1) is selected as the second target light source. Moreover, the light sensor 113 (1, 1) is selected as the first detection light sensor, and the light sensor 113 (1, 3) is selected as the second detection light sensor. Then, in the state where only the light source 111 (1, 1, 1) and the light source 111 (1, 3, 1) are turned on, light detection using the light sensor 113 (1, 1) and the light sensor 113 (1, 3) is performed.

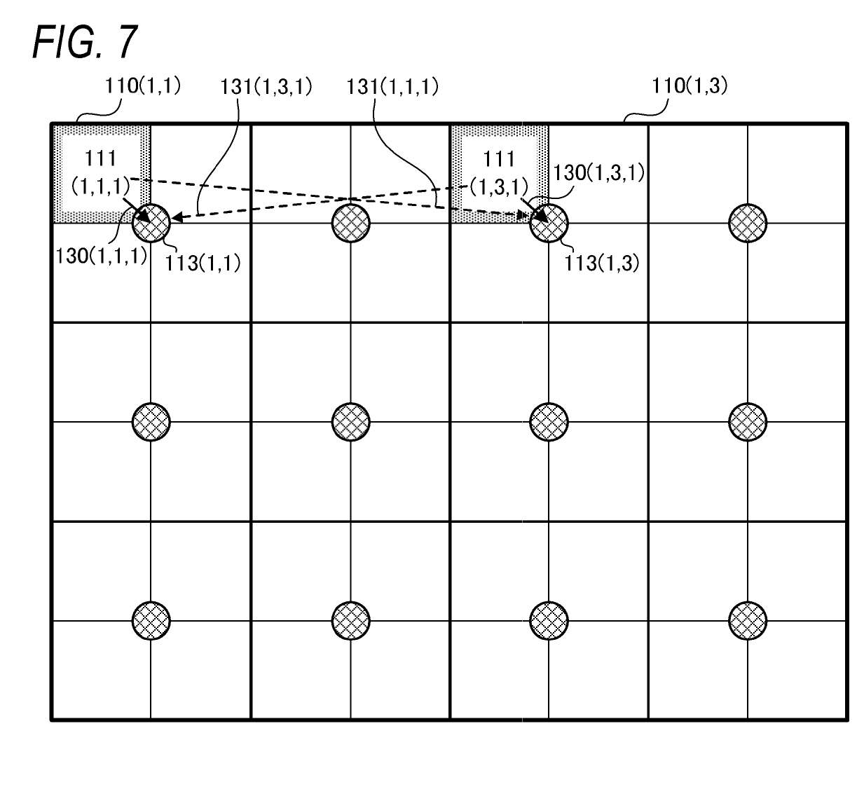

FIG. 7 is a schematic view illustrating an example of a lighting state in the first light emission adjusting processing.

In the example of FIG. 7, a total of two light sources 111, i.e., the light source 111 (1, 1, 1) and the light source 111 (1, 3, 1) are turned on, and all of the other light sources 111 are off. As illustrated in FIG. 7, corresponding light 130 (1, 1, 1) that is light from the light source 111 (1, 1, 1) and leaked light 131 (1, 3, 1) that is light from the light source 111 (1, 3, 1) enter the light sensor 113 (1, 1) that corresponds to the light source 111 (1, 1, 1). Corresponding light 130 (1, 3, 1) from the light source 111 (1, 3, 1) and leaked light 131 (1, 1, 1) from the light source 111 (1, 1, 1) enter the light sensor 113 (1, 3) that corresponds the light source 111 (1, 3, 1). Corresponding light 130 that enters a light sensor 113 is light from a light source that corresponds the light sensor 113. Leaked light 131 that enters a light sensor 113 is light from a light source that does not correspond to the light sensor 113.

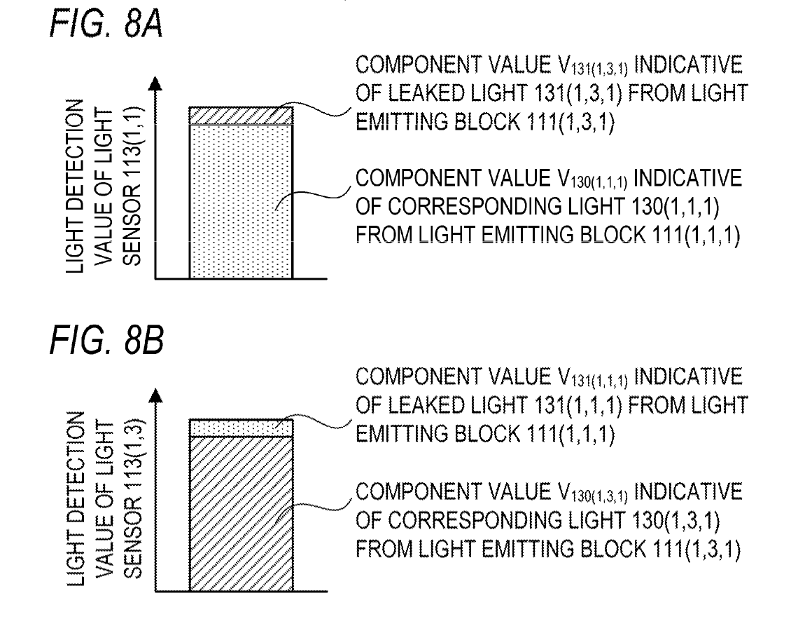

FIGS. 8A and 8B are schematic views each illustrating an example of a light detection value obtained by a light sensor 113 in the first light emission adjusting processing.

FIG. 8A illustrates a light detection value obtained by the light sensor 113 (1, 1). As illustrated in FIG. 8A, the light detection value obtained by the light sensor 113 (1, 1) contains a component value V_{130 (1, 1, 1)} indicative of the corresponding light 130 (1, 1, 1) from the light source 111 (1, 1, 1) and a component value V_{131 (1, 3, 1)} indicative of the leaked light 131 (1, 3, 1) from the light source 111 (1, 3, 1).

FIG. 8B illustrates a light detection value obtained by the light sensor 113 (1, 3). As illustrated in FIG. 8B, the light detection value obtained by the light sensor 113 (1, 3) contains a component value V_{130 (1, 3, 1)} indicative of the corresponding light 130 (1, 3, 1) from the light source 111 (1, 3, 1) and a component value V_{131 (1, 1, 1)} indicative of the leaked light 131 (1, 1, 1) from the light source 111 (1, 1, 1).

Hereinafter, a light detection value that contains a component value V_{A} and a component value V_{B} is referred to as V_{[A+3]}. For example, a light detection value obtained by the light sensor 113 (1, 3) in a state where only the light source 111 (1, 1, 1) and the light source 111 (1, 3, 1) are turned on is referred to as V_{[130 (1, 3, 1)+131 (1, 1, 1)]}.

In the microcomputer 125, a component value V₁₃₁ indicative of leaked light 131 is removed from a light detection value obtained by the light sensor 113 by using the influence information. Thus, a light value indicative of corresponding light 130 is acquired.

In a case where two light sources 111 that are away from each other are selected as the two (N) light sources 111 that are concurrently turned on, a light detection value whose error caused by leaked light is small can be acquired. However, according to the present embodiment, a light value whose error caused by leaked light is further reduced can be acquired.

An example of an acquiring method of the influence information is described below.

In the present embodiment, only a single light source is turned on. A degree of influence E of light from the single light source on light detection values obtained by light sensors that correspond to the other light sources is acquired on the basis of a light detection value obtained in this state by a light sensor that corresponds to the single light source and the light detection values obtained in this state by the light sensors that correspond to the other light sources. The influence information is acquired by sequentially turning on the plurality of light sources and performing the above processing.

The degree of influence E of light from the single light source may be or may not be acquired for all of the light sensors other than the light sensor that corresponds to the single light source. For example, the degree of influence E of light from the single light source may be acquired only for a light sensor that corresponds to a light source that turned on concurrently with the single light source in the light emission adjusting processing.

The present embodiment describes an example in which the degree of influence E is acquired by using a single image display apparatus, but is not limited to this. It is also possible that a plurality of degrees of influence be acquired from a plurality of image display apparatuses, and a representative value (an average value, a mode value, an intermediate value, a maximum value, a minimum value, etc.) of the plurality of degrees of influence be acquired as the final degree of influence E.

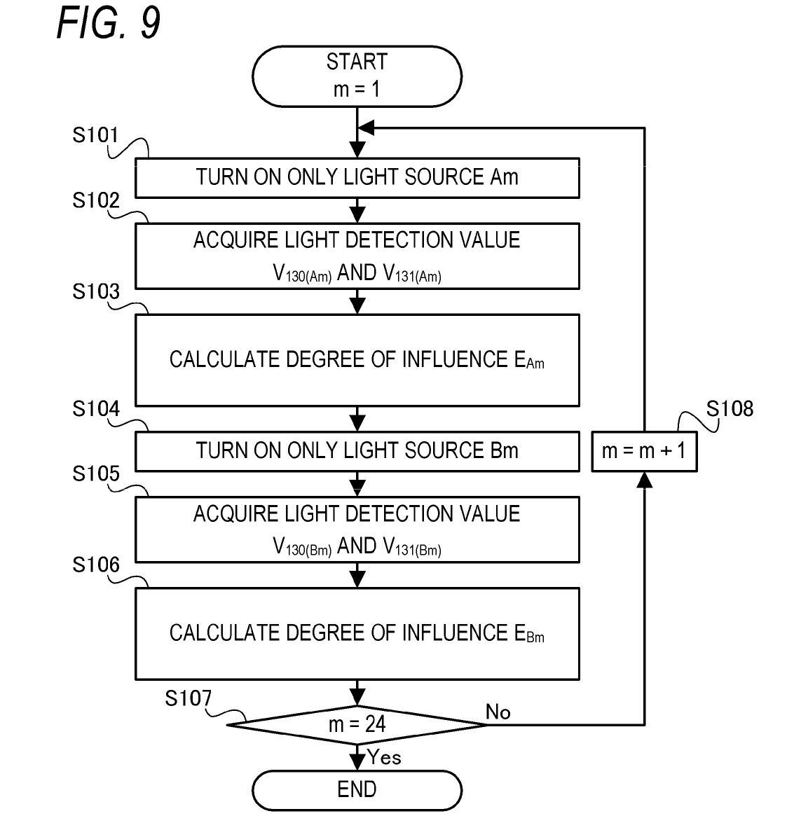

FIG. 9 is a flowchart illustrating an example of a procedure of acquiring the degree of influence E.

The following processing may be or may not be performed by the microcomputer 125. For example, in a case where the backlight apparatus has the recording unit that acquires and records the influence information, processing in S103 and processing in S106 may be performed by the recording unit. Furthermore, part of or all of the following processing may be performed by a manufacturer of the image display apparatus.

First, only a light source Am which is the first target light source in an m-th light emission adjusting processing is turned on (S101).

It is assumed that the value of m is initialized to 1 at the start of the processing flow of FIG. 9.

Next, light detection values of detection light sensors in m-th light emission adjusting processing are acquired (S102). Specifically, a light detection value V_{130 (Am)} indicative of corresponding light 130 (Am) from the light source Am is acquired by using a first detection light sensor that corresponds to the light source Am. Then, a light detection value V_{131 (Am)} indicative of leaked light 131 (Am) from the light source Am is acquired by using a second detection light sensor that corresponds to a light source Bm that is the second target light source in the m-th light emission adjusting processing.

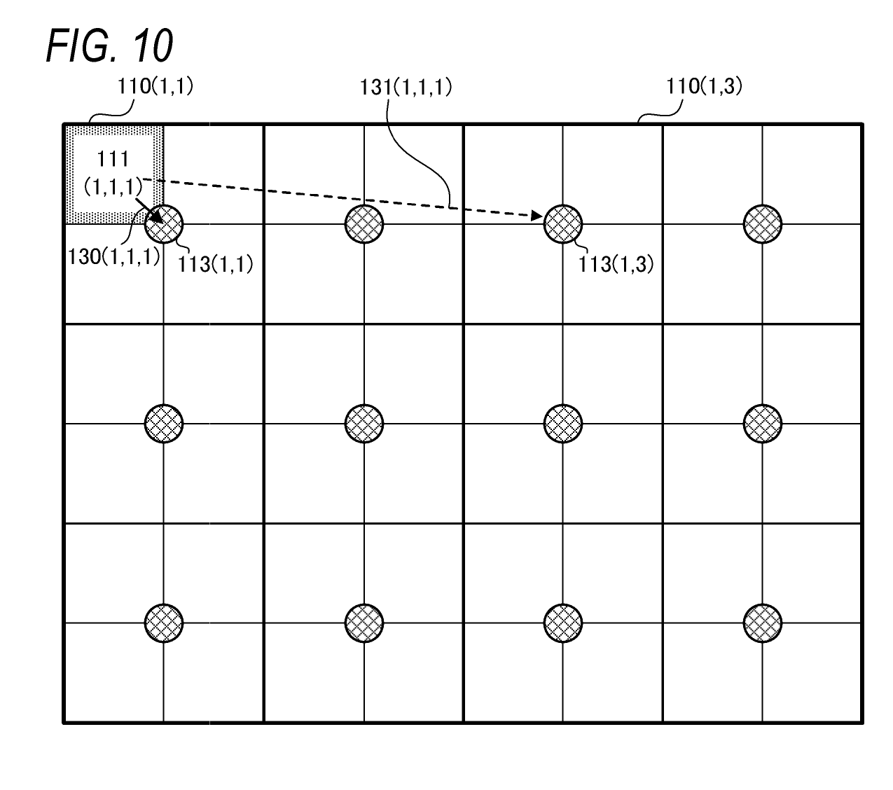

FIG. 10 is a schematic view illustrating an example of the processing in S101 and S102 performed in a case where m is 1. In a case where m is 1, only the light source 111 (1, 1, 1) is turned on. Then, a light detection value V_{130 (1, 1, 1)} indicative of the corresponding light 130 (1, 1, 1) from the light source 111 (1, 1, 1) is acquired by using the light sensor 113 (1, 1). Furthermore, a light detection value V_{131 (1, 1, 1)} indicative of the leaked light 131 (1, 1, 1) from the light source 111 (1, 1, 1) is acquired by using the light sensor 113 (1, 3).

Then, a degree of influence E_{Am} of light (leaked light) from the light source Am on a light detection value of a light sensor that corresponds to the light source Bm is calculated on the basis of the light detection value V_{130 (Am)} and the light detection value V_{131 (Am)} (S103). In the present embodiment, the degree of influence E_{Am} is calculated by using the following equation 1. That is, the degree of influence E_{Am} is calculated by dividing the light detection value V_{131 (Am)} by the light detection value V_{130 (Am)}.

E_{Am}=V_{131 (Am)}/V_{130 (Am)} equation 1

The degree of influence E_{Am} is recorded in the non-volatile memory 126.

Next, only the light source Bm is turned on (S104).

Then, light detection values of detection light sensors in the m-th light emission adjusting processing are acquired (S105). Specifically, a light detection value V_{130 (Bm)} indicative of corresponding light 130 (Bm) from the light source Bm is acquired by using the second detection light sensor that corresponds to the light source Bm. Then, a light detection value V_{131 (Bm)} indicative of leaked light 131 (Bm) from the light source Bm is acquired by using the first detection light sensor that corresponds to the light source Am.

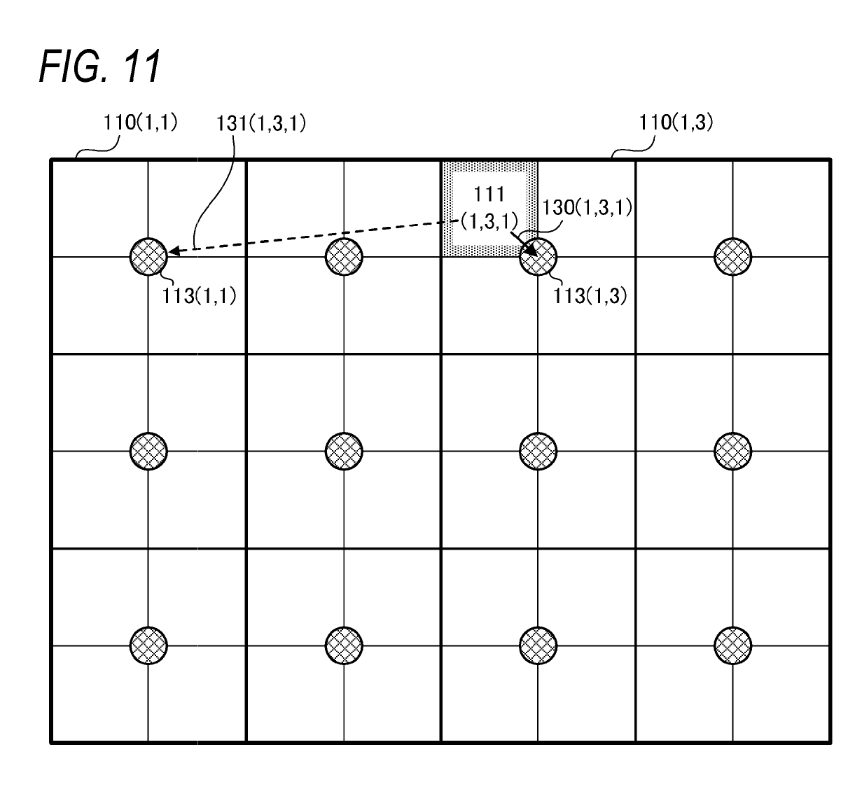

FIG. 11 is a schematic view illustrating an example of processing in S104 and S105 performed in a case where m is 1. In a case where m is 1, only the light source 111 (1, 3, 1) is turned on. Then, a light detection value V_{130 (1, 3, 1)} indicative of the corresponding light 130 (1, 3, 1) from the light source 111 (1, 3, 1) is acquired by using the light sensor 113 (1, 3). Furthermore, a light detection value V_{131 (1, 3, 1)} indicative of the leaked light 131 (1, 3, 1) from the light source 111 (1, 3, 1) is acquired by using the light sensor 113 (1, 1).

A degree of influence E_{Bm} of light (leaked light) from the light source Bm on a light detection value of the light sensor that corresponds to the light source Am is calculated on the basis of the light detection value V_{130 (Bm)} and the light detection value V_{131 (Bm)} (S106). In the present embodiment, the degree of influence E_{Bm} is calculated by using the following equation 2. That is, the degree of influence E_{Bm} is calculated by dividing the light detection value V_{131 (Bm)} by the light detection value V_{130 (Bm)}.

E_{Bm}=V_{131 (Bm)}/V_{130 (Bm)} equation 2

The degree of influence E_{Bm} is recorded in the non-volatile memory 126.

Then, it is determined whether m is 24 or not (S107). In a case where m is 24, it is determined that the degree of influence E has been calculated for all of the light sources, and this flow is finished. In a case where m is less than 24, it is determined that there is a light source for which the degree of influence E has not been calculated, the value of m is incremented by 1 in S108, and the processing returns to S101. Then, the processing in S101 to S108 is repeated until the degree of influence E is calculated for all of the light sources. Specifically, the processing in S101 to S108 is repeated until m becomes 24.

The following describes an example of an acquiring method of a light value by the microcomputer 125.

In the present embodiment, N relational expressions (N relational equations) that correspond to the N light sensors that are concurrently used in the light emission adjusting processing are prepared in advance. Such relational expressions are recorded in advance, for example, in the non-volatile memory 126. The microcomputer 125 calculates N light values of the N light sources that are concurrently turned on in the light emission adjusting processing by solving simultaneous equations with N variables that are made up of relational expressions for the respective light sensors (respective detecting units).

In the present embodiment, a relational expression indicative of a relationship among a detection value of a light sensor (light sensor that corresponds to the relational expression) obtained in a state where the N light sources are turned on, N−1 degrees of influence on the detection values, and N light values of the N light sources is prepared in advance. Specifically, the following equation 3 is prepared in advance. In the equation 3, V_{A} is a detection value of a light sensor A (detecting unit A) obtained in a state where the N light sources are being turned on by the microcomputer 125. E_{SX} is a degree of influence of light from a light source SX (SX is an integer of not less than 1 and not more than N−1) on the detection value V_{A}. The light source SX is a light source that is different from a light source SA that corresponds to the light sensor A out of the N light sources. V_{SA} is a light value of the light source SA, and V_{SX} is a light value of the light source SX.

$$\begin{matrix}[ Math . 1 ] & \\ {V}_{A} = {V}_{SA} + {\sum }_{SX = 1}^{N - 1} {V}_{SX} \times {E}_{SX} & equation 3\end{matrix}$$

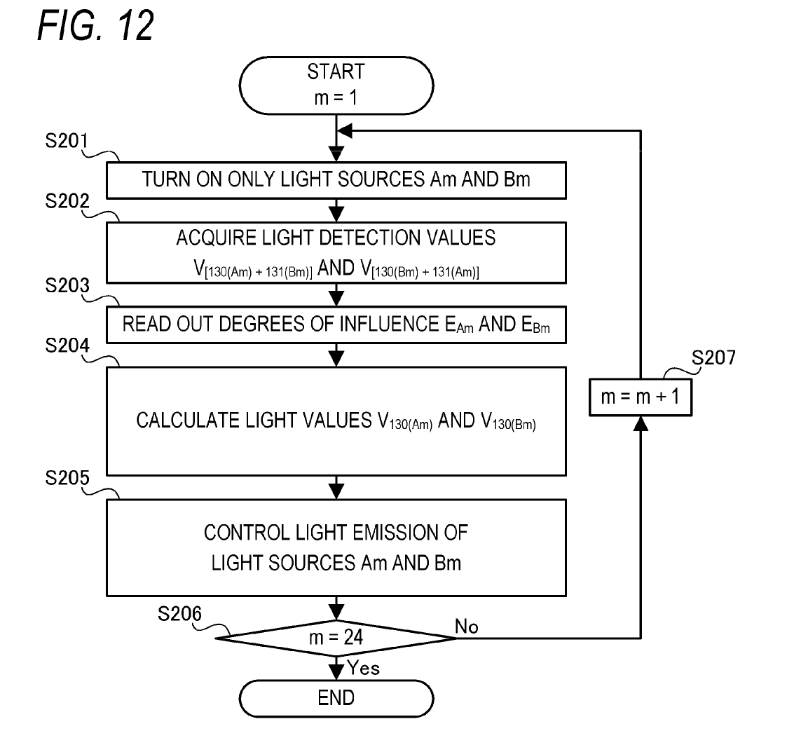

FIG. 12 is a flowchart illustrating an example of a procedure of the light emission adjusting processing.

The following processing may be or may not be performed by the microcomputer 125. For example, in a case where the backlight apparatus includes the acquiring unit that acquires a light value, processing in S202 to S204 may be performed by the acquiring unit.

It is assumed that the value of m is initialized to 1 at the start of the processing flow of FIG. 12.

First, only the light source Am and the light source Bm that are the first target light source and the second target light source in the m-th light emission adjusting processing, respectively are turned on (S201).

Next, light detection values of detection light sensors in the m-th light emission adjusting processing are acquired (S202). Specifically, a light detection value V_{[130 (Am)+131 (Bm)]} is acquired by using the first detection light sensor that corresponds to the light source Am, and a light detection value V_{[130 (Bm)+131 (Am)]} is acquired by using the second detection light sensor that corresponds to the light source Bm.

Then, the degrees of influence E_{Am} and E_{Bm} are read out from the non-volatile memory 126 (S203).

Next, the light value V_{130 (Am)} of the light source Am and the light value V_{130 (Bm)} of the light source Bm are calculated by using the detection values acquired in S202 and the degrees of influence read out in S203 (S204).

The processing in S204 is described below in detail.

As illustrated in FIG. 8A, the light detection value V_{[130 (Am)+131 (Bm)]} is a sum of the component value V_{130 (Am)} and the component value V_{131 (Bm)}. As shown in the equation 2, the component value V_{131 (Bm)} is a product of the component value V_{130 (Bm)} and the degree of influence E_{Bm}. Accordingly, the following equation 4 is established among the light detection value V_{[130 (Am)+131 (Bm)]}, the component value V_{130 (Am)}, the component value V_{130 (Bm)}, and the degree of influence E_{Bm}. The following equation 4 is prepared in advance as a relational expression for the first detection light sensor that corresponds to the light source Am.

V_{[130 (Am)+131 (Bm)]}=V_{130 (Am)}+(V_{130 (Bm)}×E_{Bm}) equation 4

Similarly, the following equation 5 is established among the light detection value V_{[130 (Bm)+131 (Am)]}, the component value V_{130 (Am)}, the component value V_{130 (Bm)}, and the degree of influence E_{Am}. The following equation 5 is prepared in advance as a relational expression for the second detection light sensor that corresponds to the light source Bm.

V_{[130 (Bm)+131 (Am)]}−V_{130 (Bm)}+(V_{130 (Am)}×E_{Am}) equation 5

In S204, the component value V_{130 (Am)} is calculated as a light value of the light source Am, and the component value V_{130 (Bm)} is calculated as a light value of the light source Bm by solving simultaneous equations with 2 variables that are made up of the equation 4 and the equation 5.

Next, light emission of the light sources Am and Bm is controlled so that the light values V_{130 (Am)} and V_{130 (Bm)} calculated in S204 coincide with target values (S205). Specifically, light emission of the light source Am is controlled so that the light value V_{130 (Am)} coincides with a target value of the light source Am, and light emission of the light source Bm is controlled so that the light value V_{130 (Bm)} coincides with a target value of the light source Bm.

Then, it is determined whether m is 24 or not (S206). In a case where m is 24, it is determined that light values of all of the light sources have been calculated, and this flow is finished. In a case where the value of m is less than 24, it is determined that there is a light source for which a light value has not been calculated, the value of m is incremented by 1 in S207, and the processing returns to S201. Then, the processing in S201 to S207 is repeated until light values of all of the light sources are calculated. Specifically, the processing in S201 to S207 is repeated until the value of m becomes 24.

It should be noted that the processing in S206 may be performed after S204, and then after light values of all of the light sources are acquired, light emission of all of the light sources may be controlled.

As described above, according to the present embodiment, influence information indicative of a degree of influence of light from a light source on a light sensor that does not correspond to the light source is prepared in advance for each combination of the light source and the light sensor that does not correspond to the light source. Then, N light values of N light sources are acquired on the basis of N light detection values of the N light sensors that are obtained in a state where the N light sources are turned on and the influence information. This makes it possible to accurately acquire light values of all of the light sources in a short time. Specifically, since the N light sources are turned on concurrently, it is possible to shorten a period of time which it takes to acquire the light values of all of the light sources as compared with a case where the light sources are turned on one by one. Furthermore, the influence of leaked light can be excluded from a light detection value by using the influence information, and it is therefore possible to accurately acquire a light value.

According to the present embodiment, since light emission of a light source is controlled by using the light value thus acquired, it is possible to accurately control light emission of the light source. For example, it is possible to accurately reduce unevenness (unexpected unevenness) caused by a difference in the temperature among the light sources 111, a difference in the degree of aged deterioration among the light sources 111, etc.

Although the present embodiment has described an example in which a target value of a light value is determined in advance, the target value is not limited to this. For example, the target value may be determined on the basis of input image data. Specifically, a characteristic value indicative of luminance of image data to be displayed in a region of a screen that corresponds to a light source may be acquired, and a target value of the light source may be determined in accordance with the characteristic value thus acquired. Alternatively, a characteristic value indicative of luminance of the whole input image data may be acquired, and a target value of each light source may be determined on the basis of the characteristic value thus acquired. In this case, the target value may be a higher value as the luminance of the image data is higher. Alternatively, the target value may be a higher value as the luminance of the image data is lower.

The present embodiment has described an example in which N light values are calculated by solving simultaneous equations with N variables that are made up of N relational expressions, but is not limited to this. For example, the light values may be acquired by using a table or a function to which N light detection values and a single degree of influence are inputted and which outputs a single light value. Specifically, the light values may be acquired by using a table or a function to which the light detection value V_{[130 (Am)+131 (Bm)]}, the light detection value V_{[130 (Bm)+131 (Am)]}, and the degree of influence E_{Am} are inputted and which outputs the light value V_{130 (Am)} and to which the light detection value V_{[130 (Am)+131 (Bm)]}, the light detection value V_{[130 (Bm)+131 (Am)]}, and the degree of influence E_{Bm} are inputted and which outputs the light value V_{130 (Bm)}.

The present embodiment has described an example in which the ratio of light detection values is calculated as the degree of influence E and a component value indicative of leaked light is calculated by multiplying the light detection value by the degree of influence E, but is not limited to this. For example, a difference between the light detection values may be calculated as the degree of influence E. Then, a component value indicative of leaked light may be calculated by adding or subtracting the degree of influence E to or from the light detection value.

### Embodiment 2

A light source apparatus and a control method of the light source apparatus according to Embodiment 2 of the present invention are described below.

Embodiment 1 has described an example in which two light sources are concurrently turned on in the light emission adjusting processing. The present embodiment describes an example in which more than two light sources are concurrently turned on in the light emission adjusting processing. Specifically, the present embodiment describes an example in which three light sources are concurrently turned on in the light emission adjusting processing. That is, the present embodiment describes an example in which N is 3.

It should be noted that, in the following description, a configuration and processing that are different from those in Embodiment 1 are described in detail, and description of an identical configuration and identical processing to those in Embodiment 1 is omitted.

A configuration of an image display apparatus according to the present embodiment is roughly identical to that of Embodiment 1 (FIG. 1). Furthermore, a configuration of a backlight apparatus according to the present embodiment is roughly identical to that of Embodiment 1 (FIGS. 2 to 5).

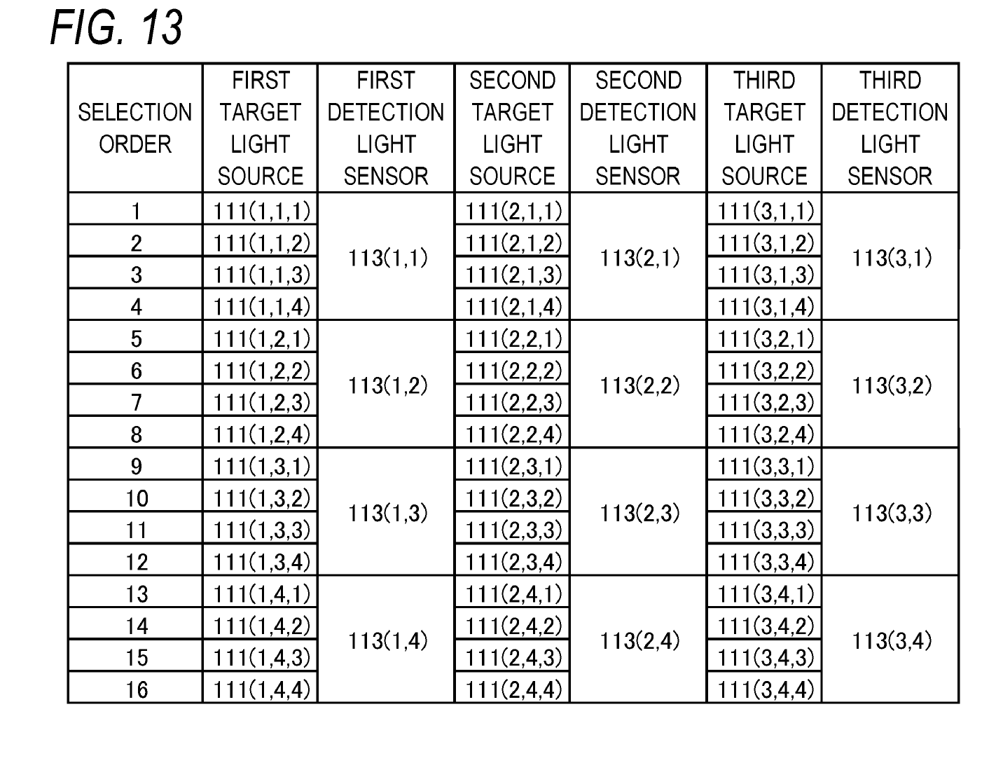

FIG. 13 is a view illustrating an example of the selection order of light sources 111 that are turned on in the light emission adjusting processing and light sensors 113 that are used for light detection in light emission adjusting processing. In the present embodiment, three light sources 111, that is, a first target light source, a second target light source, and a third target light source are turned on in the order illustrated in FIG. 13. Then, in the state where the three light sources 111 are turned on, light detection using three light sensors 113, that is, a first detection light sensor, a second detection light sensor, and a third detection light sensor is performed.

In the example of FIG. 13, one of a plurality of light sources 111 that are disposed in an upper ⅓ region of the backlight apparatus when viewed from a front direction (the color liquid crystal panel 105 side) is selected as the first target light source. One of a plurality of light sources 111 that are disposed in a lower ⅓ region is selected as the third target light source, and one of a plurality of light sources 111 that are disposed in a remaining central ⅓ region is selected as the second target light source. Then, a light sensor 113 that corresponds to the first target light source is selected as the first detection light sensor, a light sensor 113 that corresponds to the second target light source is selected as the second detection light sensor, and a light sensor 113 that corresponds to the third target light source is selected as the third detection light sensor.

For example, in the first light emission adjusting processing, a light source 111 (1, 1, 1) is selected as the first target light source, a light source 111 (2, 1, 1) is selected as the second target light source, and a light source 111 (3, 1, 1) is selected as the third target light source. Furthermore, a light sensor 113 (1, 1) is selected as the first detection light sensor, a light sensor 113 (2, 1) is selected as the second detection light sensor, and a light sensor 113 (3, 1) is selected as the third detection light sensor. Then, in a state where only the light source 111 (1, 1, 1), the light source 111 (2, 1, 1), and the light source 111 (3, 1, 1) are turned on, light detection using the light sensor 113 (1, 1), the light sensor 113 (2, 1), and the light sensor 113 (3, 1) is performed.

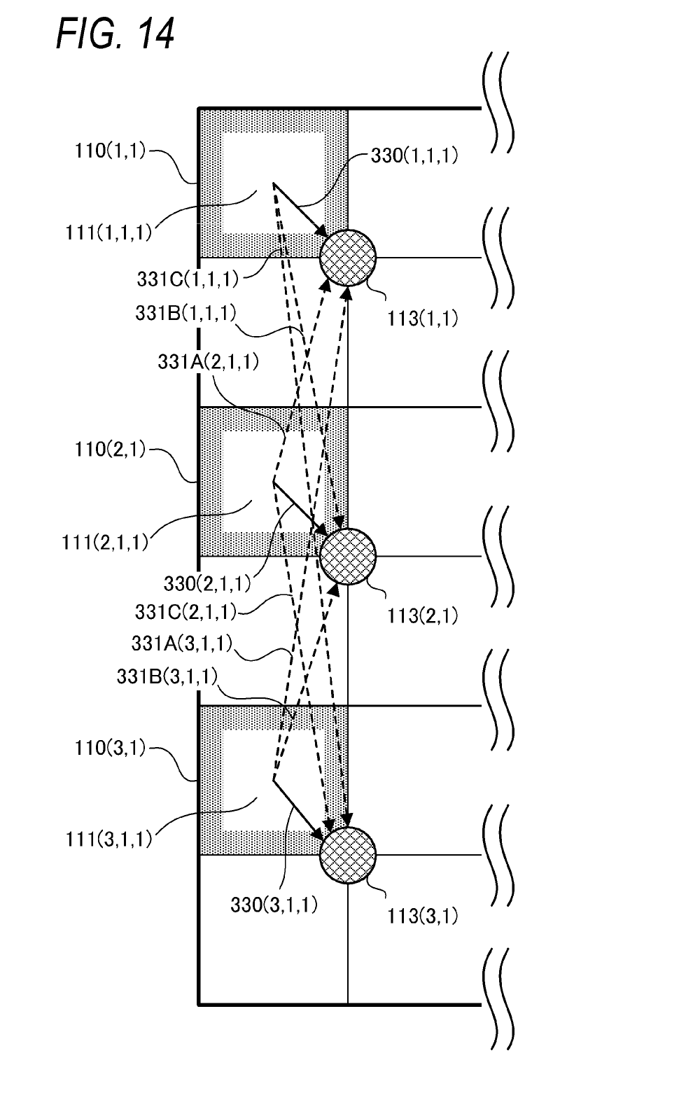

FIG. 14 is a schematic view illustrating an example of a lighting state in the first light emission adjusting processing.

In the example of FIG. 14, a total of three light sources 111, that is, the light source 111 (1, 1, 1), the light source 111 (2, 1, 1), and the light source 111 (3, 1, 1) are turned on, and all of the other light sources 111 are off.

As illustrated in FIG. 14, corresponding light 330 (1, 1, 1) from the light source 111 (1, 1, 1) enters the light sensor 113 (1, 1) that corresponds to the light source 111 (1, 1, 1). Moreover, as illustrated in FIG. 14, leaked light 331A (2, 1, 1) from the light source 111 (2, 1, 1) and leaked light 331A (3, 1, 1) from the light source 111 (3, 1, 1) also enter the light sensor 113 (1, 1).

Corresponding light 330 (2, 1, 1) from the light source 111 (2, 1, 1) enters the light sensor 113 (2, 1) that corresponds to the light source 111 (2, 1, 1). Moreover, leaked light 331B (1, 1, 1) from the light source 111 (1, 1, 1) and leaked light 331B (3, 1, 1) from the light source 111 (3, 1, 1) also enter the light sensor 113 (2, 1).

Corresponding light 330 (3, 1, 1) from the light source 111 (3, 1, 1) enters the light sensor 113 (3, 1) that corresponds to the light source 111 (3, 1, 1). Moreover, leaked light 331C (1, 1, 1) from the light source 111 (1, 1, 1) and leaked light 331C (2, 1, 1) from the light source 111 (2, 1, 1) enter the light sensor 113 (3, 1).

In this way, in the present embodiment, synthetic light of one kind of corresponding light and two kinds of leaked light enters a detection light sensor in the light emission adjusting processing.

In the present embodiment, influence information is recorded in the non-volatile memory 126 as in Embodiment 1.

An acquiring method of the influence information (degree of influence E) is identical to that in Embodiment 1.

Hereinafter, a degree of influence of leaked light from a light source Am on a light detection value of a light sensor that corresponds to a light source Bm is referred to as E_{Am-Bm} and a degree of influence of leaked light from the light source Am on a light detection value of a light sensor that corresponds to a light source Cm is referred to as E_{Am-Cm}. Similarly, a degree of influence of leaked light from the light source Bm on a light detection value of a light sensor that corresponds to the light source Am is referred to as E_{Bm-Am}, and a degree of influence of leaked light from the light source Bm on a light detection value of a light sensor that corresponds to the light source Cm is referred to as E_{Bm-Cm}. A degree of influence of leaked light from the light source Cm on a light detection value of a light sensor that corresponds to the light source Am is referred to as E_{Cm-Am}, and a degree of influence of leaked light from the light source Cm on a light detection value of a light sensor that corresponds to the light source Bm is referred to as E_{Cm-Bm}. The light source Am is the first target light source in the m-th light emission adjusting processing, the light source Bm is the second target light source in the m-th light emission adjusting processing, and the light source Cm is the third target light source in the m-th light emission adjusting processing.

In the present embodiment, only the first target light source Am, the second target light source Bm, and the third target light source Cm are turned on in the m-th light emission adjusting processing. Then, in such a lighting state, a light detection value V_{[330 (Am)+331A (Bm)+331A (Cm)]} of the first detection light sensor, a light detection value V_{[330 (Bm)+331B (Am)+331B (Cm)]} of the second detection light sensor, and a light detection value V_{[330 (Cm)+331C (Am)+331C (Bm)]} of the third detection light sensor are acquired. As has been described above, the first detection light sensor is a light sensor 113 that corresponds to the first target light source Am, the second detection light sensor is a light sensor 113 that corresponds to the second target light source Bm, and the third detection light sensor is a light sensor 113 that corresponds to the third target light source Cm.

Here, the light detection value V_{[330 (Am)+331A (Bm)+331A (Cm)]} is a sum of a component value V_{330 (Am)} indicative of corresponding light from the light source Am, a component value V_{331A (Bm)} indicative of leaked light from the light source Bm, and a component value V_{331A (Cm)} indicative of leaked light from the light source Cm. The component value V_{331A (Bm)} is a product of a component value V_{330 (Bm)} indicative of corresponding light from the light source Bm and the degree of influence E_{Bm-Am}, and the component value V_{331A (Cm)} is a product of a component value V_{330 (Cm)} indicative of corresponding light from the light source Cm and the degree of influence E_{Cm-Am}. Accordingly, the relationship expressed by the following equation 6 is established among the light detection value V_{[330 (Am)+331A (Bm)+331A (Cm)]}, the component value V_{330 (Am)}, the component value V_{330 (Bm)}, the degree of influence E_{Bm-Am}, the component value V_{330 (Cm)}, and the degree of influence E_{Cm-Am}. The following equation 6 is prepared in advance as a relational expression for the first detection light sensor that corresponds to the light source Am.

V_{[330 (Am)+331A (Bm)+331A (Cm)]}=V_{330 (Am)}+(V_{330 (Bm)}×E_{Bm-Am})+(V_{330 (Cm)}×E_{Cm-Am}) equation 6

Similarly, the relationship expressed by the following equation 7 is established among the light detection value V_{[330 (Bm)+331B (Bm)+331B (Cm)]}, the component value V_{330 (Am)}, the component value V_{330 (Bm)}, the degree of influence E_{Am-Bm}, the component value V_{330 (Cm)}, and the degree of influence E_{Cm-Bm}. The following equation 7 is prepared in advance as a relational expression for the second detection light sensor that corresponds to the light source Bm.

V_{[330 (Bm)+331B (Am)+331B (Cm)}]=V_{330 (Bm)}+(V_{330 (Am)}×E_{Am-Bm})+(V_{330 (Cm)}×E_{Cm-Bm}) equation 7

The relationship expressed by the following equation 8 is established among the light detection value V_{[330 (Cm)+331C (Am)+331C (Bm)]}, the component value V_{330 (Am)}, the component value V_{330 (Bm)}, the degree of influence E_{Am-Cm}, the component value V_{330 (Cm)}, and the degree of influence E_{Bm-Cm}. The following equation 8 is prepared in advance as a relational expression for the third detection light sensor that corresponds to the light source Cm.

V_{[330 (Cm)+331C (Am)+331C (Bm)]}=V_{330 (Cm)}+(V_{330 (Am)}×E_{Am-Cm})+(V_{330 (Bm)}×E_{Bm-Cm}) equation 8

In the present embodiment, the component value V_{330 (Am)} is calculated as a light value of the light source Am, the component value V_{330 (Bm)} is calculated as a light value of the light source Bm, and the component value V_{330 (Cm)} is calculated as a light value of the light source Cm by solving simultaneous equations with 3 variables that are made up of the equations 6 to 8.

Even in a case where the value of N is more than 3, N relational expressions can be derived in a similar manner. Then, light values of N light sources that are concurrently turned on in the light emission adjusting processing can be accurately calculated by solving simultaneous equations with N variables that are made up of N relational expressions.

As has been described above, according to the present embodiment, even in a case where the value of N is 3 or more, it is possible to accurately acquire light values of light sources as in Embodiment 1. Furthermore, by increasing the value of N, it is possible to further shorten a period of time which it takes to acquire light values of all light sources.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s).

This application claims the benefit of Japanese Patent Application No. 2013-229445, filed on Nov. 5, 2013, which is hereby incorporated by reference herein in its entirety.

What is claimed is:

1. An image display apparatus comprising:
N detecting units, N being an integer of 2 or more;
a light emitting unit having n light sources for each of the detecting units, n being an integer of 2 or more;
a display unit configured to display an image on a screen by modulating light from the light emitting unit; and
a control unit configured to control light emission of the light sources,
in a state where N light sources that correspond to the N detecting units are being turned on by the control unit, each of the detecting units detects synthetic light of light from a light source that corresponds to the detecting unit and light from a light source other than the light source that corresponds to the detecting unit,
the image display apparatus further comprising:
a storage unit configured to store, for each combination of the light source and a detecting unit that does not correspond to the light source, a degree of influence of light from the light source on a detection value of the detecting unit; and
an acquiring unit configured to acquire, for each of the N light sources, a light value indicative of light from the light source on the basis of N detection values of the N detecting units that are obtained in the state where the N light sources are being turned on by the control unit and the degree of influence for each combination,
wherein the control unit performing processing of turning on the N light sources that correspond to the N detecting units n times to acquire light values of N×n light sources.

2. The image display apparatus according to claim 1, wherein
a relational expression is determined in advance for each of the detecting units, the relational expression showing an relationship among a detection value of the detecting unit as obtained in the state where the N light sources are being turned on by the control unit, N−1 degree of influence on the detection value, and N light values of the N light sources, and
the acquiring unit calculates the N light values by solving simultaneous equations with N variables that are made up of the relational expressions for the respective detecting units.

3. The image display apparatus according to claim 2, wherein
the relational expression for a detecting unit A is as follows:
$$\begin{matrix}[ Math . 1 ] \\ {V}_{A} = {V}_{SA} + {\sum }_{SX = 1}^{N - 1} {V}_{SX} \times {E}_{SX}\end{matrix}$$
where V_{A} is a detection value of the detecting unit A as obtained in the state where the N light sources are being turned on by the control unit, E_{SX} is a degree of influence of light from a light source SX on the detection value V_{A} where SX is an integer of not less than 1 and not more than N−1, V_{SA} is a light value of a light source SA that corresponds to the detecting unit A, and V_{SX} is a light value of the light source SX.

4. The image display apparatus according to claim 1, further comprising:
a recording unit configured to acquire, on the basis of a detection value obtained by a detecting unit corresponding to a single light source in a state where only the single light source is being turned on by the control unit and a detection value obtained by other detecting unit in the state where only the single light source is being turned on by the control unit, a degree of influence of light from the single light source on the detection value of the other detecting unit, and record the degree of influence in the storage unit.

5. The image display apparatus according to claim 4, wherein the recording unit calculates the degree of influence of the light from the single light source on the detection value of the other detecting unit by dividing the detection value of the other detecting unit by the detection value of the detecting unit corresponding to the single light source.

6. The image display apparatus according to claim 1, wherein the control unit controls light emission of each of the light sources so that a light value of the light source coincides with a target value.

7. The image display apparatus according to claim 1, wherein the detecting units detect brightness of light.

8. The image display apparatus according to claim 1, wherein the detecting units detect color of light.

9. A light source apparatus comprising:
N detecting units, N being an integer of 2 or more;
a light emitting unit having n light sources for each of the detecting units, n being an integer of 2 or more; and
a control unit configured to control light emission of the light sources,
in a state where N light sources that correspond to the N detecting units are being turned on by the control unit, each of the detecting units detects synthetic light of light from a light source that corresponds to the detecting unit and light from a light source other than the light source that corresponds to the detecting unit,
the light source apparatus further comprising:
a storage unit configured to store, for each combination of the light source and a detecting unit that does not correspond to the light source, a degree of influence of light from the light source on a detection value of the detecting unit; and
an acquiring unit configured to acquire, for each of the N light sources, a light value indicative of light from the light source on the basis of N detection values of the N detecting units that are obtained in the state where the N light sources are being turned on by the control unit and the degree of influence for each combination,
wherein the control unit performing processing of turning on the N light sources that correspond to the N detecting units n times to acquire light values of N×n light sources.

10. A control method of an image display apparatus including:
N detecting units, N being an integer of 2 or more;
a light emitting unit having n light sources for each of the detecting units, n being an integer of 2 or more;
a display unit configured to display an image on a screen by modulating light from the light emitting unit; and
a storage unit configured to store, for each combination of a light source and a detecting unit that does not correspond to the light source, a degree of influence of light from the light source on a detection value of the detecting unit,
the control method comprising:
a control step of controlling light emission of the light sources; and
an acquiring step of acquiring, for each of the light sources, a light value indicative of light from the light source,
wherein, in a state where N light sources that correspond to the N detecting units are being turned on in the control step, each of the detecting units detects synthetic light of light from a light source that corresponds to the detecting unit and light from a light source other than the light source that corresponds to the detecting unit,
in the acquiring step, for each of the N light sources, a light value indicative of light from the light source is acquired on the basis of N detection values of the N detecting units that are obtained in the state where the N light sources are being turned on in the control step and the degree of influence for each combination, and
in the control step, processing of turning on the N light sources that correspond to the N detecting units is performed n times to acquire light values of N×n light sources.

11. The control method according to claim 10, wherein
a relational expression is determined in advance for each of the detecting units, the relational expression showing an relationship among a detection value of the detecting unit as obtained in the state where the N light sources are being turned on in the control step, N−1 degree of influence on the detection value, and N light values of the N light sources, and
in the acquiring step, the N light values are calculated by solving simultaneous equations with N variables that are made up of the relational expressions for the respective detecting units.

12. The control method according to claim 11, wherein
the relational expression for a detecting unit A is as follows:
$$\begin{matrix}[ Math . 2 ] & \\ {V}_{A} = {V}_{SA} + {\sum }_{SX = 1}^{N - 1} {V}_{SX} \times {E}_{SX} & \end{matrix}$$
where V_{A} is a detection value of the detecting unit A as obtained in the state where the N light sources are being turned on in the control step, E_{SX} is a degree of influence of light from a light source SX on the detection value V_{A} where SX is an integer of not less than 1 and not more than N−1, V_{SA} is a light value of a light source SA that corresponds to the detecting unit A, and V_{SX} is a light value of the light source SX.

13. The control method according to claim 10, further comprising:
a recording step of acquiring, on the basis of a detection value obtained by a detecting unit corresponding to a single light source in a state where only the single light source is being turned on in the control step and a detection value obtained by other detecting unit in the state where only the single light source is being turned on in the control step, a degree of influence of light from the single light source on the detection value of the other detecting unit, and recording the degree of influence in the storage unit.

14. The control method according to claim 13, wherein, in the recording step, the degree of influence of the light from the single light source on the detection value of the other detecting unit is calculated by dividing the detection value of the other detecting unit by the detection value of the detecting unit corresponding to the single light source.

15. The control method according to claim 10, wherein in the control step, light emission of each of the light sources is controlled so that a light value of the light source coincides with a target value.

16. The control method according to claim 10, wherein, the detecting units detect brightness of light.

17. The control method according to claim 10, wherein, the detecting units detect color of light.

18. A control method of a light source apparatus including:
N detecting units, N being an integer of 2 or more;
a light emitting unit having n light sources for each of the detecting units, n being an integer of 2 or more; and
a storage unit configured to store, for each combination of a light source and a detecting unit that does not correspond to the light source, a degree of influence of light from the light source on a detection value of the detecting unit,
the control method comprising:
a control step of controlling light emission of the light sources; and
an acquiring step of acquiring, for each of the light sources, a light value indicative of light from the light source,
wherein, in a state where N light sources that correspond to the N detecting units are being turned on in the control step, each of the detecting units detects synthetic light of light from a light source that corresponds to the detecting unit and light from a light source other than the light source that corresponds to the detecting unit,
in the acquiring step, for each of the N light sources, a light value indicative of light from the light source is acquired on the basis of N detection values of the N detecting units that are obtained in the state where the N light sources are being turned on in the control step and the degree of influence for each combination, and
in the control step, processing of turning on the N light sources that correspond to the N detecting units is performed n times to acquire light values of N×n light sources.

19. A non-transitory computer readable medium that stores a program, wherein the program causes a computer to execute the control method according to claim 10.

20. A non-transitory computer readable medium that stores a program, wherein the program causes a computer to execute the control method according to claim 18.
